(19) United States
(12) Patent Application Publication
(10) Pub. No.: US 2014/0244887 A1
(43) Pub. Date: Aug. 28, 2014

(54) DATA PROCESSING APPARATUS AND CONTROL METHOD

(71) Applicant: CANON KABUSHIKI KAISHA, Tokyo (JP)

(72) Inventor: Yuichirou Kimijima, Yokohama-shi (JP)

(73) Assignee: CANON KABUSHIKI KAISHA, Tokyo (JP)

(21) Appl. No.: 14/176,522

(22) Filed: Feb. 10, 2014

(30) Foreign Application Priority Data
Feb. 28, 2013 (JP) 2013-040027

(51) Int. Cl. G06F 13/40

(52) U.S. Cl. CPC G06F 13/4018
USPC 710/307

(57) ABSTRACT

A connected access request is generated by connecting access requests that are issued within a period of carrying out connections from when a initially received leading access request is issued. At this time the period of carrying out connections is set so that access to data corresponding to the connected access request is completed within a time from when the leading access request is issued until other access to a memory device is performed.

### BACKGROUND OF THE INVENTION

1. Field of the Invention

The present invention relates to a data processing apparatus and a control method, and particularly to a technology for controlling access to a memory device.

2. Description of the Related Art

Data processing apparatuses such as digital cameras and the like are provided with various signal processing functions. In recent years there has been a trend of increasing the amount of data targeted for signal processing such as image data for example, and the amount of processing has also increased in response to this. For this reason, improvements in response performance and the like and greater speeds are called for in regard to these signal processing functions. Furthermore, in image processing and the like, the data targeted for processing is stored in a memory device that is connected via a bus such as an SDRAM or the like, and operations are carried out such as applying the processing while reading out the stored data. The processing circuit (client) that achieves the signal processing function via the memory device and the memory device are connected via a bus master and a bus. Buses of greater bandwidth are being implemented to achieve greater speeds of memory access at this time for writing or reading out large volumes of data from the bus master to the memory device.

However, sometimes the design of the internal circuitry of the client has not been optimized for the bandwidth of a broadband bus. In such a case, a mismatch occurs when the bus master transmits to the broadband bus the data that has been received from the client, and there is a probability that the access efficiency is reduced.

Here, an example of a reduction in access efficiency is described with reference to FIG. 9A. This diagram schematically shows the processing in a case where an image processing circuit (client) carries out write-access (writing) to an SDRAM via a bus by way of a DMAC (direct memory access controller), which is a bus master.

In the case of carrying out write-access, the client first sends to the DMAC a write-request for the SDRAM. At this time, along with the write-request, the client sends information of the write-address and burst length (transfer length). Upon receiving the write-request, the DMAC returns a write-acknowledge signal to the client.

Upon receiving the write-acknowledge signal from the DMAC, the client starts write-access. In the example of FIG. 9A, the data width of one set of data of the client is 32 bits and the burst length is eight. In this case, the client sends to the DMAC a burst length of data, that is, eight consecutive sets of data. In other words, 32×8=256 bits of data are sent to the bus via the DMAC in response to a single write-request.

On the other hand, the data width for access to the SDRAM is 128 bits. In other words, 128÷32=4 sets of data sent from the client are written with one access of the DMAC to the SDRAM.

Furthermore, the burst length for access to the SDRAM is determined according to the processing method of data in the selected SDRAM. Specifically, the number of bits that can be processed in a single cycle within the SDRAM is defined in advance. For example, in a DDR2 type SDRAM, 4 bits of data can be processed in a single cycle, and this is referred to as a 4-bit prefetch. That is, in the case of a 4-bit prefetch, the minimum burst length of the SDRAM is 4 bursts, and the transfer length cannot be shorter than this. In other words, in the example of FIG. 9A, the data length 128×4=512 bits of 4 bursts to be written from the DMAC to the SDRAM is the single-time write-access transfer length of the DMAC.

In contrast to this, since the data length to be sent from the client with a single-time write-request is 256 bits, access for the latter half two bursts to the SDRAM involves processing to no purpose as for the SDRAM write data shown in the lower area of FIG. 9A. It should be noted that the access for the latter half two bursts is in fact masked by a mask signal and no writing is performed to the SDRAM. That is, due to this disparity between the data access length of the DMAC to the SDRAM and the data access length for a single-time write-request, there is a problem in that access to the SDRAM is performed to no purpose.

Japanese Patent Laid-Open No. 2000-132497 discloses a manner of improving efficiency of access to the bus by shortening the transfer time by reducing the number of times of data transfer from the DMAC when an arbitrary amount of data is to be transferred according to DMA transfer. Furthermore, in a similar manner, in the environment of FIG. 9A for example, it is conceivable that access from the DMAC to the SDRAM to no purpose can be avoided by bundling write-requests of two times from the client as shown in FIG. 9B before sending this to the DMAC.

However, as is evident by comparing FIG. 9A and FIG. 9B, with methods involving bundling requests in consideration of the transfer length to the SDRAM, there is a longer time (latency) from sending the data corresponding to the first write-request until it is written to the SDRAM. Furthermore, in a case where write-requests cannot be carried out continuously as shown in FIG. 9B, that is, in a case where there is an open time from the issuance of the first write-request until the second write-request is issued, the latency is further increased.

Problems such as the following occur when there is a large latency from the sending of data from the client until the data is written to the SDRAM. There is a probability that another client that is to perform processing by reading out data that has been written to the SDRAM, or the actual client that has carried out the writing, will undesirably carry out a read-access to the same data even though the writing to the SDRAM has not been completed. That is, there is a probability that a read-access of the SDRAM by the client will undesirably overtake a write-access to the SDRAM by the client.

### SUMMARY OF THE INVENTION

The present invention was made in view of such problems in the conventional technique. The present invention provides a data processing apparatus and a control method that can favorably control memory access to memory devices.

The present invention in its first aspect provides a data processing apparatus comprising: a processing unit configured to output a first access request for writing data to a memory device via a first bus having a first data width; a connection unit configured to generate a single second access request by connecting a plurality of first access requests outputted from the processing unit via the first bus, and outputs the second access request; a controller configured to set a period for the connection unit to execute a connection process for generating the single second access request, and controls the connection unit so that the plurality of first access requests outputted in one the period are connected; and a memory control unit configured to control access to the memory device via a second bus having a second data width greater than the first data width, wherein the memory control unit receives the second access request outputted from the connection unit and outputs the second access request to the memory device via the second bus.

The present invention in its second aspect provides a control method of a data processing apparatus, comprising: a processing step of outputting a first access request for writing data to a memory device via a first bus having a first data width; a connection step of generating a single second access request by connecting multiple first access requests outputted in the processing step via the first bus, and outputting the second access request; a control step of setting a period for the connection step to execute a connection process for generating the single second access request, and controlling operation of the connection step so that the multiple first access requests outputted in one the period are connected; and a memory control step of controlling access to the memory device via a second bus having a second data width greater than the first data width; wherein in the memory control step, the second access request outputted in the connection step is received and the second access request is outputted to the memory device via the second bus.

Further features of the present invention will become apparent from the following description of exemplary embodiments (with reference to the attached drawings).

### BRIEF DESCRIPTION OF THE DRAWINGS

FIG. 1 is a block diagram showing a functional configuration of a digital camera 100 according to an embodiment of the present invention.

FIG. 2 is a block diagram that illustrates an internal configuration of a detection processing system 103 according to an embodiment of the present invention.

FIG. 3 is a block diagram showing a detailed configuration of a write-request connection unit 204 according to embodiment 1 of the present invention.

FIG. 4 is a diagram for describing a request connection process according to an embodiment of the present invention.

FIG. 5 is a diagram for describing a timeout time in the request connection process according to an embodiment of the present invention.

FIG. 6 is a flowchart that illustrates a processing system access process executed by the digital camera 100 according to embodiment 1 of the present invention.

FIG. 7 is a block diagram showing a detailed configuration of the write-request connection unit 204 according to embodiment 2 of the present invention.

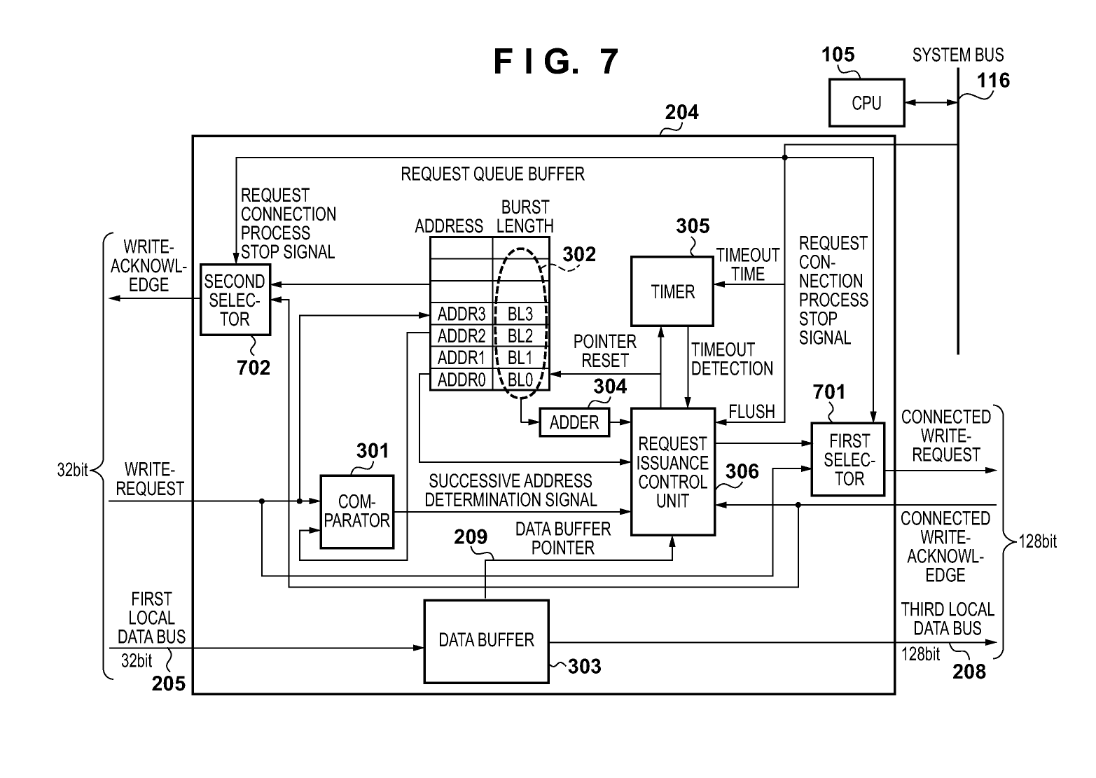

FIG. 8 is a flowchart that illustrates a processing system access process executed by the digital camera 100 according to embodiment 2 of the present invention.

FIGS. 9A and 9B are diagrams for describing conventional memory access.

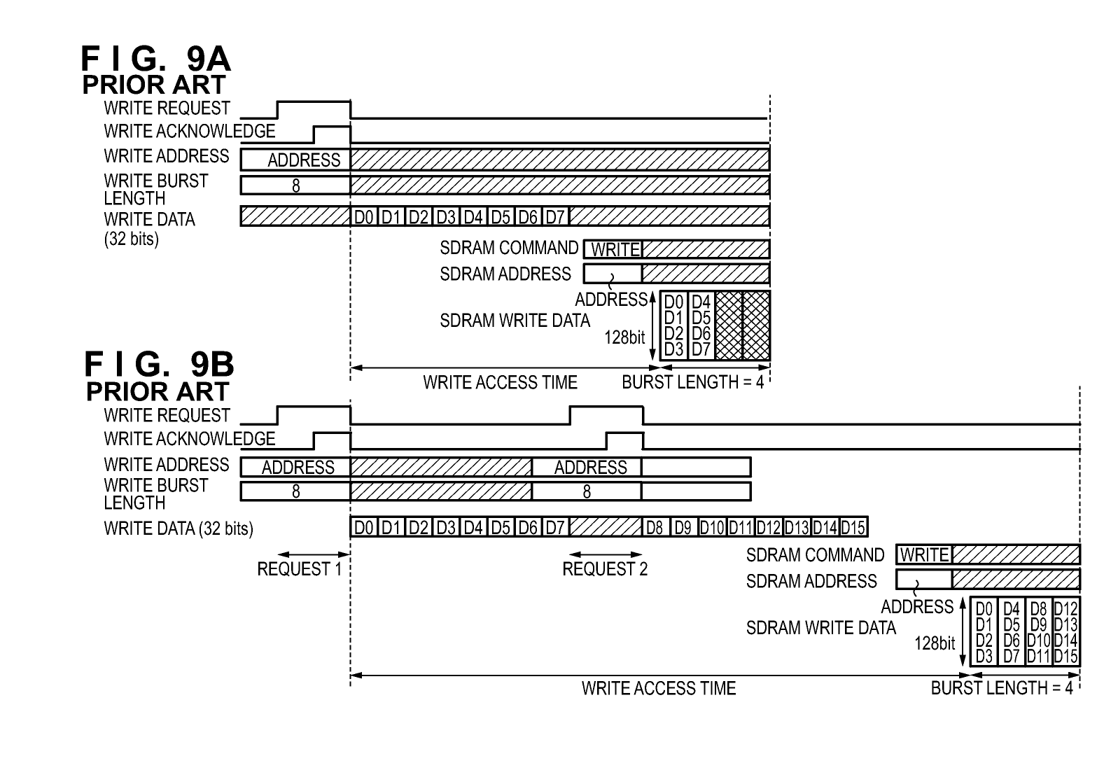

### DESCRIPTION OF THE EMBODIMENTS

### First Embodiment

Hereinafter, illustrative embodiments of the present invention are described in detail with reference to the accompanying drawings. It should be noted in regard to the single embodiment described below that description is given of an example in which the present invention is applied to a digital camera in which multiple processing systems carry out processing while writing or reading out data to or from an SDRAM and this is one example of a data processing apparatus. However, the present invention is applicable to any device in which it is possible for multiple processing systems to alternately access a memory device.

Configuration of Digital Camera 100

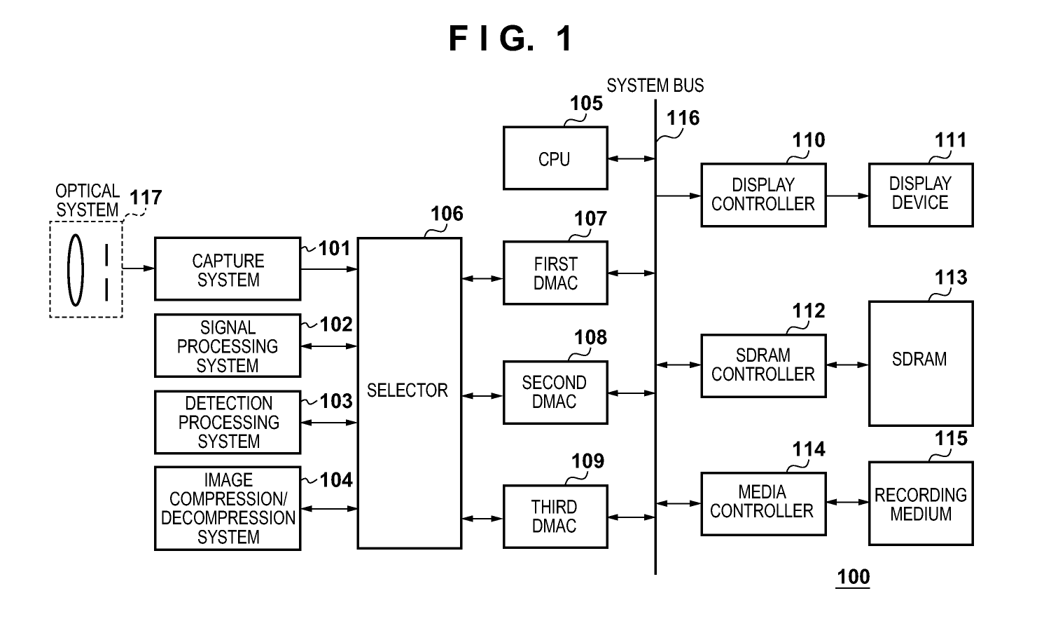

FIG. 1 is a block diagram showing a functional configuration of a digital camera 100 according to an embodiment of the present invention.

A CPU 105 controls the operations of the various blocks provided in the digital camera 100. Specifically, the CPU 105 reads out an operation program of the digital camera 100 stored in an unshown ROM, expands this in an unshown RAM and executes it to control the operations of each block.

An SDRAM 113 is a memory device that stores data to be used in the processing in the circuits of each of the processing systems of the digital camera 100 according to the present embodiment. The writing and reading out of data with respect to the SDRAM 113 is managed and carried out according to an SDRAM controller 112. The digital camera 100 according to the present embodiment has four processing systems (processing circuits) that perform the sending and receiving of data, these being an image-capture system 101, a signal processing system 102, a detection processing system 103, and an image compression/decompression system 104.

The image-capture system 101 carries out image-capture processing and generates image data. The image-capture system 101 is provided with an image-capture device such as a CCD or a CMOS sensor for example. The image-capture device performs photoelectric conversion on an optical image that has been formed onto the image-capture device through an optical system 117, thereby generating image-capture signals. Furthermore, the image-capture system 101 carries out processing relating to correlation double sampling, which removes reset noise contained in the image-capture signals, variable gain amplification, which amplifies the levels of the image-capture signals to a variable gain, and A/D conversion in which analog data is quantized into digital data. It should be noted that the optical system 117 is configured by components such as a field lens, a focus lens, and an aperture and the like.

The signal processing system 102 carries out various types of digital signal processing on the digital image data that has been generated by the image-capture system 101. Specifically, the signal processing system 102 obtains image evaluation values, which are not shown in the diagram, and carries out appropriate digital signal processing based on these evaluation values.

The detection processing system 103 carries out processes such as feature detection of the image and dynamic body tracking on the digital image data that has been generated by the image-capture system 101 or the signal processing system 102. Image data obtained by performing a pixel thinning readout or a portion of image data that has undergone block division is used in the detection processing system 103.

The image compression/decompression system 104 generates image data for recording by carrying out an encoding process according to a preset image compression format such as the JPEG format for example on the image data that has been generated by the signal processing system 102. The image data for recording that is generated is recorded on a recording medium 115, which is described later. Furthermore, the image compression/decompression system 104 carries out a decompression process on the compressed image data that is read out from the recording medium 115 and generates to the SDRAM 113 image data that is to be displayed.

In a case where there is a data transfer relating to any of the processing systems provided in the present embodiment, a selector 106 selectively connects the processing system to a first DMAC 107, a second DMAC 108, or a third DMAC 109, which are described later.

The first DMAC 107, second DMAC 108, and the third DMAC 109 are DMA transfer controllers provided in the digital camera 100 according to the present embodiment with respect to the SDRAM 113. The image-capture system 101, the signal processing system 102, the detection processing system 103, and the image compression/decompression system 104 are able to access the SDRAM 113 without going through the CPU by using the DMAC. It should be noted that in the description hereinafter, in a case where there is a reference simply to “DMAC,” this may apply to any of the first DMAC 107, the second DMAC 108, and the third DMAC 109.

A display device 111 is a display device provided in the digital camera 100 such as an LCD or the like for example. The display device 111 functions as an electronic viewfinder by performing through-display on the image data captured by the image-capture system 101. Furthermore, the display device 111 displays the image data that is read out from the recording medium 115, which has been decompressed by the image compression/decompression system 104. A display controller 110 carries out display control of the display device 111.

The recording medium 115 is an internal memory provided in the digital camera 100 for example, or a recording device that is detachably connected to the digital camera 100 such as a memory card or an HDD or the like. A media controller 114 controls the writing of data to the recording medium 115 and the reading out of data from the recording medium 115.

It should be noted that the CPU 105, each of the DMACs, the display controller 110, the SDRAM controller 112, and the media controller 114 are connected through a system bus 116. The bandwidth of the system bus 116 is designed to match the digital camera 100 and is a so-called broadband bus. Here, the CPU 105 and each of the DMACs are bus masters, and the display controller 110, the SDRAM controller 112, and the media controller 114 are bus slaves.

Internal Configurations of Each Type of Processing System

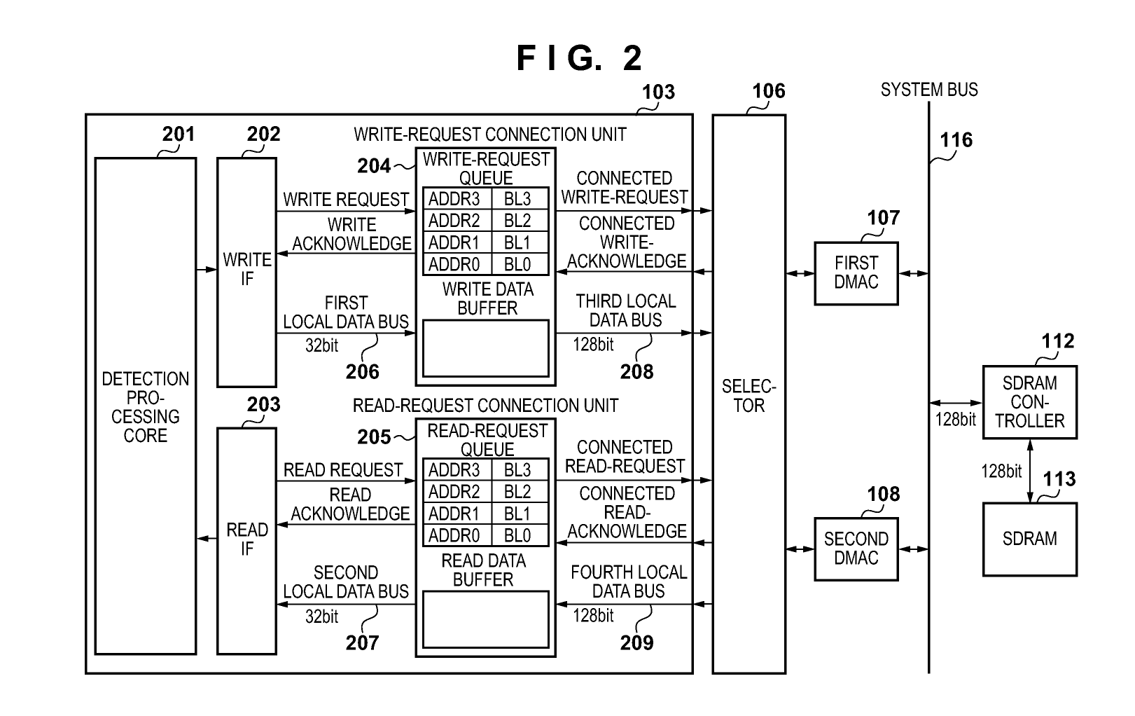

Next, description is given with reference to FIG. 2 regarding the internal configuration of each type of processing system using the detection processing system 103 as an example.

Each type of processing system has a processing core such as a chip or the like that executes the corresponding process. In the case of the detection processing system 103, a detection processing core 201 carries out detection processing. An interface to the DMAC is connected to the detection processing core 201 so that it can carry out writing to the SDRAM 113 or read out from the SDRAM 113 via the DMAC. Specifically, the detection processing core 201 is connected to a write IF 202 for data writing and a read IF 203 for data readouts.

For example, in a case where the detection processing core 201 is to carry out data writing to the SDRAM 113, first a write-request signal is issued from the detection processing core 201 to the DMAC. Then, upon receiving a write-acknowledge signal from the DMAC, which is a response to the request, the detection processing core 201 outputs the write data.

Here, as described earlier, each of the processing systems in the present embodiment is not necessarily optimized to the data width of the SDRAM 113 or the bandwidth of the system bus 116. This is because not all of the processing cores of the processing systems in the newly developed digital camera 100 are remodeled. That is, even though the bandwidth of the system bus 116 may have been expanded, there is a probability that the data width for outputting to the local bus from the interface of each processing core is unchanged.

In the present embodiment, to increase the efficiency of data transfers between each processing system and the SDRAM 113, the processing system is provided with a write-request connection unit 204 and a read-request connection unit 205, which perform connections for write-requests or read-requests. The write IF 202 and the write-request connection unit 204, and the read IF 203 and the read-request connection unit 205 are connected by a first local data bus 206 and a second local data bus 207 respectively. In the first local data bus 206 and the second local data bus 207 of the detection processing system 103 according to the present embodiment, data whose data width for one set of data is 32 bits is transmitted matching to the write IF 202 and the read IF 203.

The write-request connection unit 204 and the read-request connection unit 205 connect the requests received from the write IF 202 or the read IF 203 and send these to the DMAC as a single connected request. Furthermore, when information of the request received from the write IF 202 or the read IF 203 is stored, each connection unit outputs an acknowledge signal for the request to the write IF 202 or the read IF 203.

Furthermore, the write-request connection unit 204 stacks the data corresponding to the write-request received from the write IF 202 in an internal data buffer 303 that is described later. And upon receiving a connected write-acknowledge signal for the connected write-request, the write-request connection unit 204 outputs the data corresponding to the received connected write-requests to the selector 106 via a third local data bus 208. That is, the write-request connection unit 204 carries out access control of data to the SDRAM 113. At this time, the data width of one set of data to be outputted to the third local data bus 208 is optimized to the data width of the SDRAM 113 or the bandwidth of the system bus 116. That is, the write-request connection unit 204 according to the present embodiment converts the data width of one set of data from 32 bits to 128 bits.

On the other hand, the read-request connection unit 205 receives data read from the SDRAM 113 in accordance with the connected request in which read-requests from the read IF 203 are connected via the DMAC. The read-request connection unit 205 converts the data width of the received data to the data width handled by the read IF 203 and sends this to the second local data bus 207. That is, the read-request connection unit 205 according to the present embodiment converts the data width of one set of data from 128 bits to 32 bits.

Detailed Configuration of Write-Request Connection Unit 204

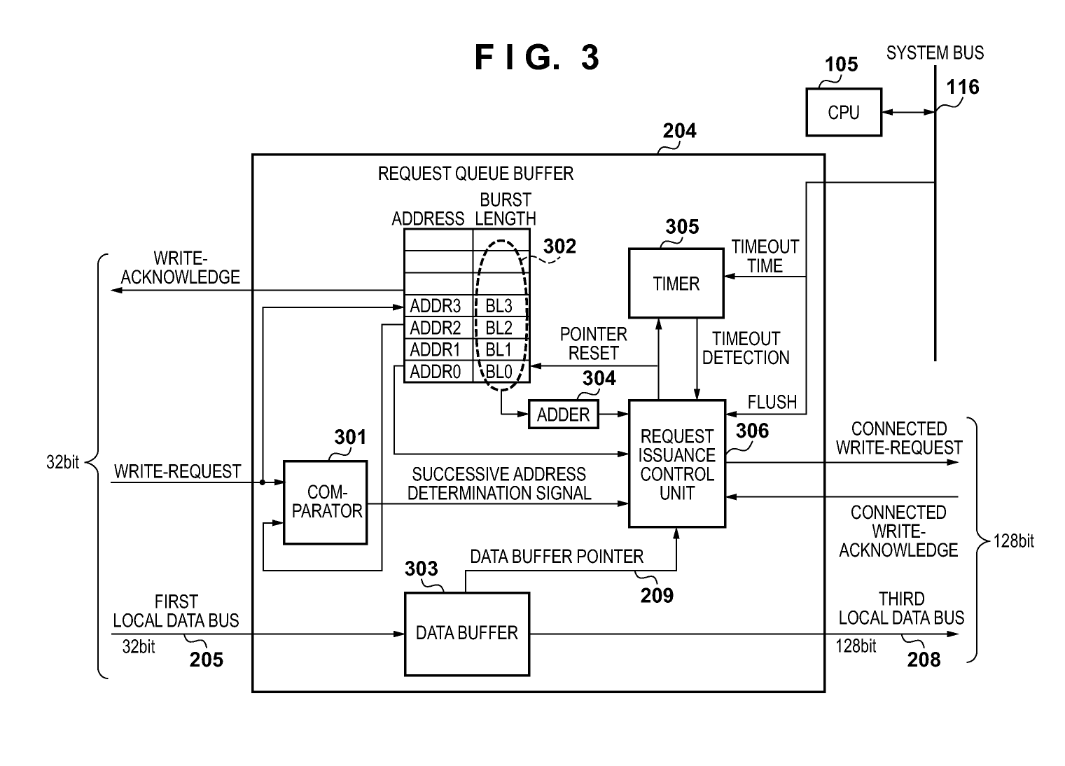

Here description is given of the write-request connection unit 204 as an example using FIG. 3 in regard to the detailed configurations of the connection units according to the present embodiment.

In the write-request connection unit 204, the write-requests that are issued by the write IF 202 are inputted to a comparator 301 and a request queue buffer 302. It should be noted that the write-requests include the following information.

information of the write address (access starting address) in the SDRAM 113 where the data is to be written

the burst length for data transfer in a single access performed by a single write-request command (number of times of successive transfers of 32 bits of data: first data length)

The request queue buffer 302 holds the information of the write address and burst length contained in the write-request that has been received. Upon storing the information of the received write-request at the address indicated by a pointer value that it manages, the request queue buffer 302 returns a write-acknowledge signal, which is a reception complete notification. It should be noted that only the information of the write-request that is to be connected may be held in the request queue buffer 302. After the connected write-request is sent, the request queue buffer 302 according to the present embodiment is reset by a request issuance control unit 306 that is to be described later.

The comparator 301 determines whether or not the write address specified by the received write-request is successive to the final address in the SDRAM 113 in which the data corresponding to the previously received write-request was written. In a case where multiple requests are to be converted to a single connected request and requests writing data in the SDRAM 113 by the single connected request as in the present embodiment, data of a predetermined data length is written from the leading address specified by the single connected request in the SDRAM 113. That is, it is necessary that the areas in the SDRAM 113 that are accessed according to the single connected request are successive. Thus, in the present embodiment, the comparator 301 determines whether or not the addresses to be accessed are successive in a case where the received write-requests are connected. Specifically, the comparator 301 determines whether or not the following relationship is established between the newest staring address specified by the received write-request and the previous starting address and previous burst length specified by the last received write-request:

(newest starting address)−(previous starting address)=(previous burst length)

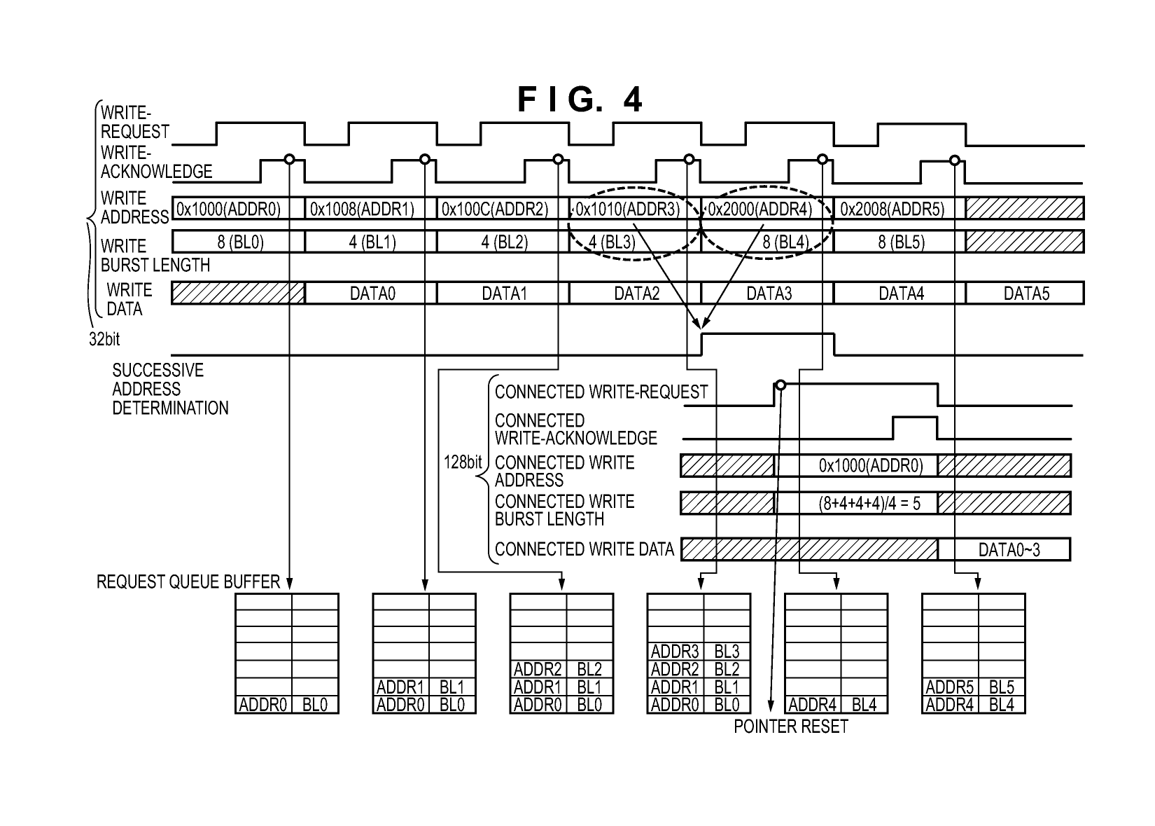

In a case where a write-request is to be carried out as shown in FIG. 4 for example, the above-described relationship is established for the first issued write-request and the second issued write-request as follows:

0x1008−0x1000=0x0008

and this corresponds to a burst length of 8 (BL0). On the other hand, the above-described relationship is not established for the fourth issued write-request and the fifth issued write-request as follows:

0x2000−0x1010=0x0FF0≠0x0004(BL3)

The comparator 301 outputs the determination result to the request issuance control unit 306, which is described later, as a successive address determination signal.

The data buffer 303 stores the data that is inputted from the write IF 202 in response to the write-acknowledge signal. Upon storing the data, the data buffer 303 outputs to the request issuance control unit 306 a pointer value of the final address where data is stored for example. The pointer value is used for the request issuance control unit 306 to keep track of the amount of data stacked in the data buffer 303.

When a connected write-request is sent to the DMAC, an adder 304 adds the burst lengths of all the requests held in the request queue buffer 302 and outputs a burst length sum total to the request issuance control unit 306.

The request issuance control unit 306 controls the issuance of connected write-requests to the DMAC. Specifically, the request issuance control unit 306 connects the write-requests that have been received until a point before it is determined that an address jump has occurred with reference to a successive address determination signal, and issues a connected write-request. The request issuance control unit 306 issues the connected write-request including write-address information contained in the initially received write-request that is held in the request queue buffer 302, and the burst length sum total (second data length) outputted by the adder 304. It should be noted that in a case where it has been determined that an address jump has occurred, the request issuance control unit 306 performs control so that storage of received write-request information and returns of write-acknowledge signals are not carried out by the request queue buffer 302.

Furthermore, upon receiving a connected write-acknowledge signal, which is a response to the connected write-request, the request issuance control unit 306 causes data corresponding to the connected write-request stored in the data buffer 303 to be sent to the third local data bus 208. In the present embodiment, the data sent from the data buffer 303 is data in which the data length of one set of data has been converted to 128 bits. In the example shown in FIG. 4 for example, a connected write-request is issued and sent to the DMAC when a write-address address jump is detected (when the successive address determination signal is high). In the case of FIG. 4, the connected write-request is issued using the write-address (0x1000) of the initially received write-request and the burst length sum total (8+4+4+4=20). It should be noted that in the present embodiment, for information of the burst length in the connected write-request, the data length of one set of data targeted for writing is converted to from 32 bits, which is the data length before the write-request connection unit 204, to 128 bits, which is the data length after the write-request connection unit 204. Thus, since it is necessary to convert the burst length in a case where one set of data is 128 bits, the information of the burst length transmitted by the connected write-request is 20÷(128÷32)=5.

Furthermore, the request issuance control unit 306 determines other conditions relating to the connecting of write-requests so that a request relating to a read out of that data is not carried out to the SDRAM 113 prior to completing the writing of data to the SDRAM 113. Specifically, the request issuance control unit 306 connects the write-requests in consideration of the time from the issuance of the initial write-request (leading write-request) among the write-requests to be connected until the writing of the connected data to the SDRAM 113 is completed.

In the present embodiment, the write-request connection unit 204 is provided with a timer 305 that measures the elapsed time from the issuance of the leading write-request. In a case where a preset time (timeout time) from the issuance of the leading write-request has elapsed, the timer 305 sends a timeout detection signal to the request issuance control unit 306. Then the request issuance control unit 306 determines write-requests that have been received at a time point when the timeout detection signal is received as write-requests targeted for connection. It should be noted that the timeout time is supplied to the timer 305 by the selector 106.

Timeout Time

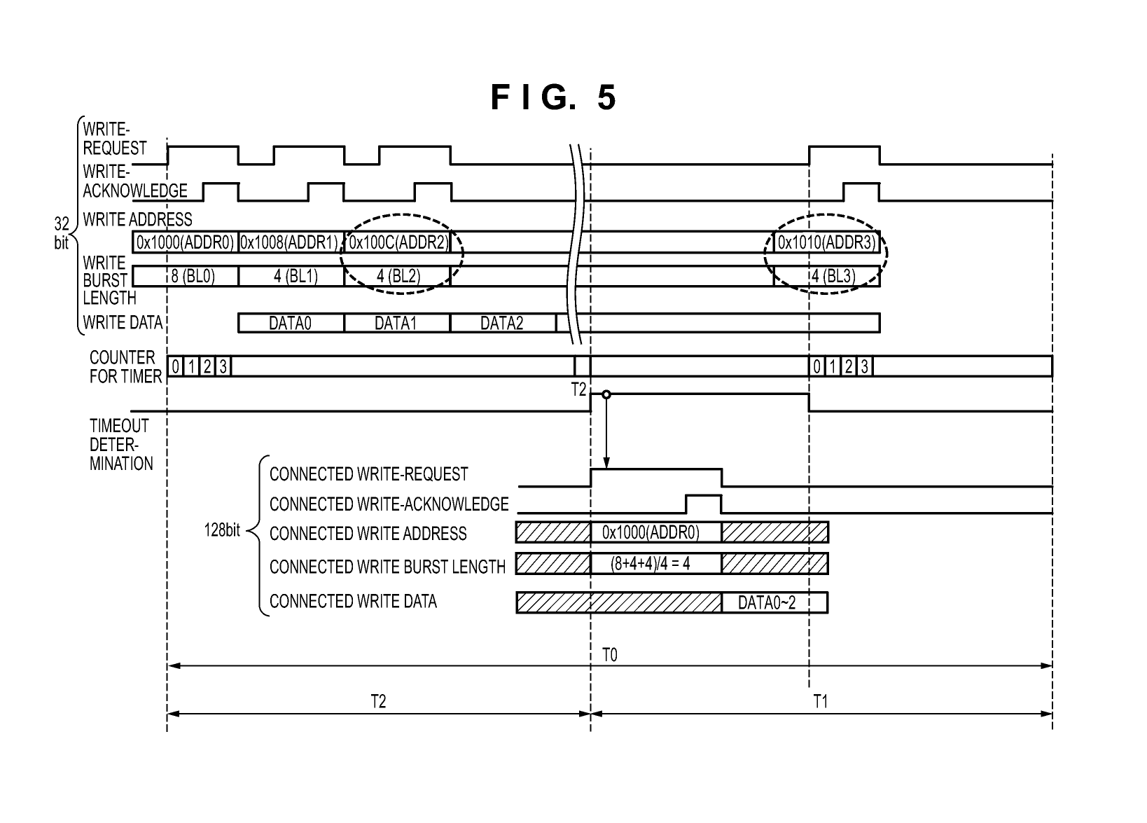

Here, the detailed description is given using FIG. 5 in regard to a method for determining the timeout time to be supplied to the timer 305.

As shown in FIG. 5, the timer 305 starts counting when the leading write-request has been issued. At this time, a timeout time T2 for determining the write-requests to be connected is determined as follows.

First, a shortest time T0 is obtained, which is from when the write-request for one set of data is issued by the write IF 202 of one processing system, until a read request for that data written in the SDRAM 113 is issued by the same or another processing system. The shortest time T0 is defined according to parallel operations or the like of the processing systems carried out in the digital camera 100.

Furthermore, a time T1 shown in this diagram indicates a maximum required time that is required from the issuance of a write-request (connected write-request) of the DMAC until that request is accepted by the SDRAM controller 112. The maximum required time T1 can be defined as follows in consideration of simultaneous access processing from the bus master to the system bus 116, which can be occur simultaneously in parallel in the digital camera 100. It should be noted that the maximum required time T1 may be varied in response to the image-capture mode that is set or the status of the digital camera 100. In this case, the CPU 105 may determine the maximum required time T1 by determining the current status of the digital camera 100 and calculating the timeout time T2 and supplying this to the timer 305.

For example, a case is conceivable such as the present embodiment in which four bus masters (the CPU 105, the first DMAC 107, the second DMAC 108, and the third DMAC 109) simultaneously perform access to the system bus 116 to access the SDRAM 113. To access the SDRAM 113, four preceding requests issued by the bus masters can be held (queued) in the SDRAM controller 112 according to the present embodiment. Furthermore, in the present example, simultaneous parallel access can occur from the four bus masters to the system bus 116. In other words, with the digital camera 100 according to the present embodiment, access to SDRAM 113 by one of the bus masters is carried out after at least the following is completed:

access relating to four queued requests (maximum number)

access of four times (maximum number) according to bus arbitration by the system bus 116.

That is, if access to the SDRAM 113 has been completed for a total of 4+4=8 times, the request to the SDRAM 113 by the first bus master is received and access becomes possible.

Here, a maximum time Tacc relating to one set of data access to the SDRAM 113 can be defined from the maximum burst length of the bus master. That is, in the present example, T1, which is a guarantee time from the issuance of a connected write-request from one of the bus masters until that is received, can be defined as Tacc×8. In this way, by subtracting the maximum required time T1 from the shortest time T0 that is defined in this manner, the timeout time T2 can be defined (T2=T0−T1). The CPU 105 supplies the timeout time T2 that has been defined in this manner to the selector 106.

Furthermore, the data buffer 303 of the write-request connection unit 204 is a limited region. For this reason, apart from the foregoing conditions, in a case where the data buffer 303 has become full (“data buffer full” received) with data to be written to the SDRAM 113, the request issuance control unit 306 discontinues the reception of write-requests to be connected. It should be noted that the capacity of the data buffer 303 is can be set to the maximum burst length to the SDRAM 113 for example.

That is, in any of the following cases, the request issuance control unit 306 according to the present embodiment connects the requests received up to that point.

1. A case where addresses to be accessed according to successively received requests are not successive.

2. A case where the timeout time from the issuance of the first request has been exceeded.

3. A case where the data buffer 303 has gone into a full state.

Access Processing of Processing Systems

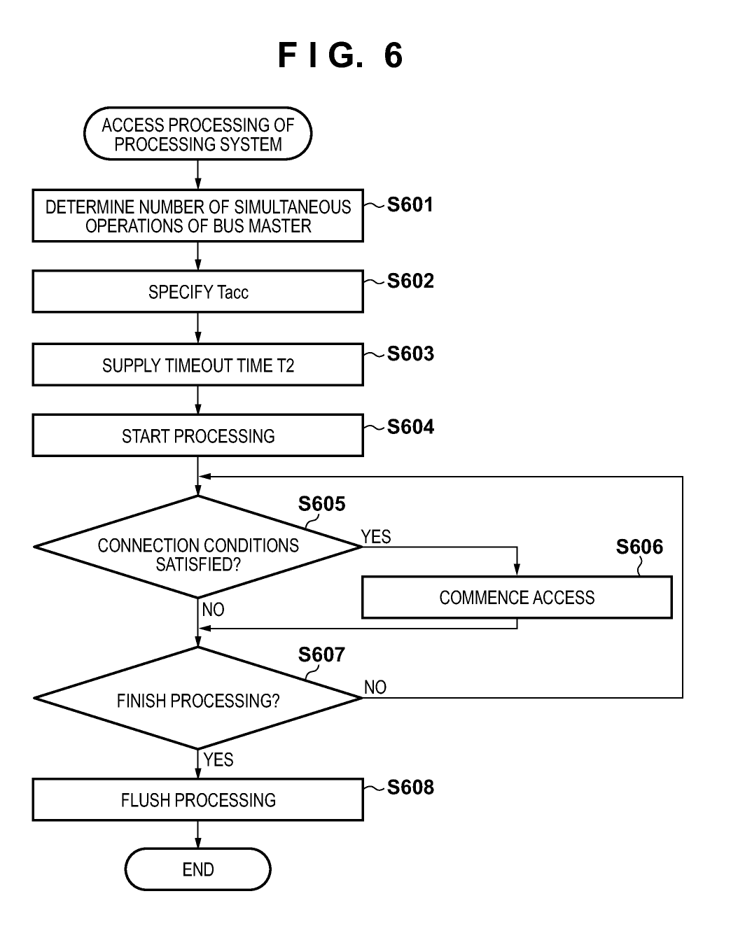

Description is given of specific processing using the flowchart of FIG. 6 in regard to the access processing of processing systems of the digital camera 100 according to the present embodiment having this configuration. It should be noted that description is given assuming that the access processing of the present processing system starts when processing is carried out requiring access to the SDRAM 113 by one of the processing systems (targeted processing system) for example.

At S601 the CPU 105 obtains the number of bus masters capable of simultaneously operating in the system bus 116. Information of the number of bus masters capable of simultaneously operating is defined in advance in response to the status of the digital camera 100 as described earlier, and is stored in the unshown ROM for example. The CPU 105 reads out this information to obtain the number of bus masters capable of simultaneously operating.

At S602, the CPU 105 specifies the bus master to carry out the longest burst transfer among the bus masters capable of simultaneously operating, and specifies the longest time Tacc relating to a one time set of data access.

At S603, the CPU 105 calculates a timeout time T2 from the shortest time T0, which is determined in advance, the longest time Tacc relating to a one time set of data access, and the number of bus masters capable of simultaneously operating, and supplies this to the timer 305 of the targeted processing system.

At S604, the targeted processing system starts processing according to the control of the CPU 105.

At S605, the request issuance control unit 306 of the targeted processing system determines whether or not any of the request connection conditions is satisfied. In a case where it is determined that the request connection condition is satisfied, the request issuance control unit 306 transitions the procedure to S606, and in a case where it is determined not to be satisfied, transitions to S607.

At S606, the request issuance control unit 306 connects the requests and outputs a connected request to the selector 106. Furthermore, upon receiving an acknowledge signal for the connected request, the request connection unit starts access to the SDRAM 113. For example, in a case of a writing operation, the write-request connection unit 204 outputs the write data stacked in the data buffer 303 to the selector 106.

At step S607, the CPU 105 determines whether or not the processing of the targeted processing system is completed. In a case where it is determined that the processing of the targeted processing system is completed, the CPU 105 transitions the procedure to S608, and in a case where it is determined not to be completed, transitions to S605.

At S608 the request connection unit executes processing relating to the received requests that are unsent under the control of the CPU 105, then ends the present processing system access process. For example, in a case of a writing operation, the write-request connection unit 204 performs a flush process on the data that remains in the data buffer 303 (forcibly writes to the SDRAM 113). Specifically, the CPU 105 executes the flush process by supplying a flush process request signal to the request issuance control unit 306.

As described above, a data processing apparatus according to the present embodiment is capable of favorably controlling memory access to a memory device. Specifically, the data processing apparatus generates a connected access request generated by connecting access requests that are issued within a period of carrying out connections from when a initially received leading access request is issued. At this time the period of carrying out connections is set so that access to data corresponding to the connected access request is completed within a time from when the leading access request is issued until other access to the memory device is performed.

By performing in this manner, it is possible to ensure that an access to the data of the SDRAM 113 to be accessed according to a connected access request by another processing system does not occur during the period in which the access requests are being connected for example. More specifically, it is possible to prevent a readout process for data written to the SDRAM 113 according to a connected access request from being carried out before the writing of the data.

### Second Embodiment

In the above-described embodiment 1, description was given supposing that the shortest time T0 was preset, with the shortest time being from when a write-request from one processing system is issued until a next read-request to the data written due to this request is issued. Generally write-access delays can occur in cases where there are many simultaneously operating bus masters and the bandwidth of the system bus 116 being used is wide. In the present embodiment, description is given hereinafter regarding processing in which it is difficult to specifically define the shortest time T0, that is, in conditions where it is difficult to define the timeout time, such as cases where the processing of the CPU 105 for example occupies a wide part of the bandwidth of the system bus 116. It should be noted that for the digital camera 100 of the present embodiment, the same reference symbols are assigned to the same configurations as those of the foregoing embodiment 1, and description thereof is omitted.

Details Configuration of Write-Request Connection Unit 204

The write-request connection unit 204 according to the present embodiment is provided with a first selector 701 and a second selector 702 in addition to the configuration of the foregoing embodiment 1.

In the present embodiment, the CPU 105 carries out control such that mismatch does not occur in accesses to the SDRAM 113 in cases where the shortest time T0 cannot be defined, or cases where a predetermined value or more of the bandwidth of the system bus 116 is used. Specifically, in a case the foregoing conditions are satisfied, the CPU 105 determines that an access delay has occurred and supplies to the first selector 701 and the second selector 702 a request connection process stop signal so that access requests are not connected.

Write-requests inputted to the write-request connection unit 204 and connected write-requests outputted from the request issuance control unit 306 are inputted to the first selector 701. In a case where a request connection process stop signal has been supplied from the CPU 105, the first selector 701 outputs without connecting the write-requests inputted to the write-request connection unit 204, that is, the write-requests outputted by the write IF 202. Furthermore, in a case where a request connection process stop signal is not supplied, the first selector 701 outputs the connected write-requests inputted by the request issuance control unit 306.

A write-acknowledge signal indicating that write-requests inputted to the write-request connection unit 204 are stored in the request queue buffer 302 and a write-acknowledge signal returned by the DMAC are inputted to the second selector 702. In a case where a request connection process stop signal has been supplied from the CPU 105, the second selector 702 outputs the write-acknowledge signal returned by the DMAC as a write-acknowledge signal of the write-request connection unit 204. The write-acknowledge signal outputted at this time is a response signal of the DMAC to the write-request outputted by the write IF 202 that is outputted by the first selector 701. Furthermore, in a case where a request connection process stop signal is not supplied, the second selector 702 outputs the write-acknowledge signal that the request queue buffer 302 outputs.

That is, in a case where the CPU 105 outputs a request connection process stop signal, the write-request connection unit 204 according to the present embodiment passes and outputs to the DMAC the access request inputted from the write IF 202. Furthermore, the write-request connection unit 204 passes and outputs to the write IF 202 the acknowledge signal returned from the DMAC.

Access Processing of Processing Systems

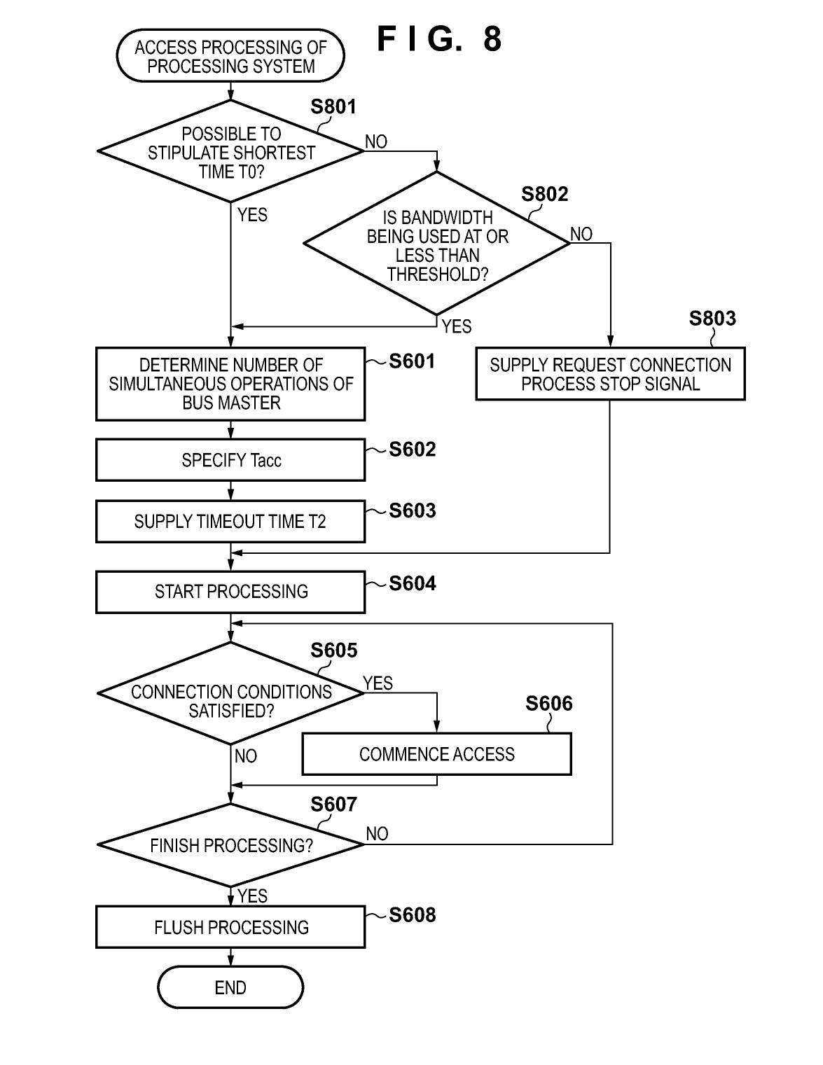

Description is given of specific processing using the flowchart of FIG. 8 in regard to the access processing of processing systems of the digital camera 100 according to the present embodiment having this configuration. It should be noted that description is given assuming that the access processing of the present processing system starts when processing is carried out requiring access to the SDRAM 113 by one of the processing systems (targeted processing system) for example. It should be noted that for the access processing of processing systems according to the present embodiment, the same reference symbols are assigned to steps for carrying out processing equivalent to the access processing of processing systems in the foregoing embodiment 1.

When processing starts, the CPU 105 determines, at S801, whether or not the shortest time T0 from the issuance of a write-request by the targeted processing system until the data written to the SDRAM 113 corresponding to the request is next read, can be defined. Specifically, the CPU 105 determines the number of bus masters currently performing simultaneous operations and the processes being carried out for example, and determines whether or not the shortest time T0 can be defined. In a case where it is determined that the shortest time T0 can be defined, the CPU 105 transitions the procedure to S601, and in a case where it is determined unable to be defined, transitions to S802.

At S802, the CPU 105 determines whether or not the bandwidth of the system bus 116 being used is a predetermined threshold or less. The bandwidth threshold may be a value with which access mismatches do not occur under conditions in which the shortest time T0 cannot be defined, obtained experimentally for example. In a case where it is determined that the bandwidth being used is the threshold or below, the CPU 105 defines the time required until the next access, which has been obtained when an access mismatch does not occur under conditions in which the shortest time T0 cannot be defined, as the shortest time T0, and transitions processing to S601. Furthermore, in a case where it is determined that the bandwidth being used is greater than the threshold, the CPU 105 transitions the processing to S803.

At S803, the CPU 105 supplies a request connection process stop signal to the write-request connection unit 204 so that request connections are not carried out, and transitions the processing to S604. It should be noted that in this case, it is always determined at S605 that the connection conditions are not satisfied.

By doing this, memory access to the memory device can be controlled favorably in response to usage conditions of the system bus 116 and processing by each of the bus masters.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-040027, filed Feb. 28, 2013, which is hereby incorporated by reference herein in its entirety.

What is claimed is:

1. A data processing apparatus comprising:
a processing unit configured to output a first access request for writing data to a memory device via a first bus having a first data width;
a connection unit configured to generate a single second access request by connecting a plurality of first access requests outputted from the processing unit via the first bus, and outputs the second access request;
a controller configured to set a period for the connection unit to execute a connection process for generating the single second access request, and controls the connection unit so that the plurality of first access requests outputted in one said period are connected; and
a memory control unit configured to control access to the memory device via a second bus having a second data width greater than the first data width,
wherein the memory control unit receives the second access request outputted from the connection unit and outputs the second access request to the memory device via the second bus.

2. The data processing apparatus according to claim 1, wherein
the controller controls the connection unit so that the first access request outputted in one said period and the first access request outputted in another said period are not connected.

3. The data processing apparatus according to claim 1, wherein
the controller sets the period so that the second access request is outputted to the memory device in an interval from when the processing unit outputs the first access request until a readout of data written to the memory device according to the first access request is requested.

4. The data processing apparatus according to claim 1, wherein
the controller sets, as a period in which the connection process is to be executed, a third period obtained by subtracting a second period, which is a period from when the memory control unit outputs an access request to the memory device until the access request is accepted, from a first period, which is a period from when the processing unit outputs the first access request until a readout of data written to the memory device according to the first access request is requested.

5. The data processing apparatus according to claim 4, further comprising:
a plurality of other processing units, which output access requests to the memory device respectively,
wherein the third period is determined in accordance with the number of the other processing units that simultaneously output access requests to the memory device.

6. The data processing apparatus according to claim 4, wherein
the memory device includes a holding unit that holds an access request received via the second bus, and
the third period is determined in accordance with the number of access requests that the holding unit holds.

7. The data processing apparatus according to claim 1, wherein
the controller controls the connection unit so that, in a first mode, a connection process for the first access request is carried out, and, in a second mode, a connection process for the first access request is not carried out.

8. The data processing apparatus according to claim 7, wherein
the controller switches the first mode and the second mode in response to a bandwidth of the second bus that is used for transfer to the memory device.

9. The data processing apparatus according to claim 1, wherein
the connection unit does not connect two of the first access requests that were outputted successively from the processing unit in one said period in a case where a discrimination is made that addresses specified by the two first access requests outputted successively are not successive.

10. The data processing apparatus according to claim 9, wherein
the first access request includes a write starting address and a data length of data to be written, and
the connection unit discriminates whether or not addresses specified by the two first access requests outputted successively are successive by comparing a difference between the write starting address of the first access request outputted earlier and the write starting address of the first access request outputted later of the two first access requests outputted successively, with the data length of the earlier outputted first access request.

11. A control method of a data processing apparatus, comprising:
a processing step of outputting a first access request for writing data to a memory device via a first bus having a first data width;
a connection step of generating a single second access request by connecting multiple first access requests outputted in the processing step via the first bus, and outputting the second access request;
a control step of setting a period for the connection step to execute a connection process for generating the single second access request, and controlling operation of the connection step so that the multiple first access requests outputted in one said period are connected; and
a memory control step of controlling access to the memory device via a second bus having a second data width greater than the first data width;
wherein in the memory control step, the second access request outputted in the connection step is received and the second access request is outputted to the memory device via the second bus.
